(19) United States
(12) Patent Application Publication
(10) Pub. No.: US 2004/0060784 A1
(43) Pub. Date: Apr. 1, 2004

(54) Pressure-accumulating brake cylinder with a release spindle indicator

(76) Inventor: Damien Gravier, Muenchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/432,866

(22) PCT Filed: Nov. 22, 2001
(86) PCT No.: PCT/EP01/13583

(30) Foreign Application Priority Data
Nov. 28, 2000 (DE) 100 58 927.8

(51) Int. Cl. F16D 65/24

(52) U.S. Cl. 188/170

(57) ABSTRACT

The invention relates to a pressure-accumulating brake cylinder (1), comprising a housing (2) in which a pressure accumulator piston (4) runs, dividing an internal chamber of the housing (2) into a pressure accumulation chamber (22) and a pressure chamber (21), a spring arrangement (221), arranged in the pressure accumulation chamber (22) and tensioning the pressure accumulator piston (4) in the direction of the pressure chamber (21) and a mechanical emergency release device (5), for the mechanical emergency release of the pressure accumulating brake cylinder (1). A linear displacement of the pressure accumulating piston (1) is thus possible, by means of the mechanical emergency release device (5), against the tension of the spring arrangement (221), with a threaded spindle (51), acting as operating device, rigidly fixed, in the axial direction, to the housing (2) and the emergency release device (5) furthermore comprises an indicator device (54) which displays the position of the pressure accumulating piston (4), relative to the operating device. It is thus possible to have a reliable display of whether the pressure accumulating brake cylinder has been released in an emergency or not, even for an emergency release device with a threaded spindle which is not unscrewed externally.

The present invention relates to a spring brake cylinder, particularly used in commercial vehicles.

Such a spring brake cylinder usually has a housing in which a spring-loaded piston is guided which divides the interior of the housing into a spring chamber and a pressure chamber. In the spring chamber a spring device is arranged which pretensions the spring-loaded piston in the direction of the pressure chamber. So that a parked or braked vehicle, in which the spring brake cylinder is arranged, can be moved, the pressure chamber is acted upon by compressed air such that the spring-loaded piston is displaced against the pretensioning effect of the spring device. As a result, a braking device coupled with the spring-loaded piston is disengaged from a brake disk or the like, so that the vehicle is no longer braked. For brake operations during the drive, such a spring brake cylinder can be coupled in a known manner with a service brake cylinder.

If, because of a pressure drop in the system, a significant reduction of the pneumatic pressure in the pressure chamber now takes place, because of the pretensioning of the spring device, the spring-loaded piston is displaced in the direction of the pressure chamber in such a manner that the braking device coupled with the spring-loaded piston engages and carries out a braking of the vehicle. For example, in the event of a tearing-off of the brake pressure pipe during the drive, it is to be reliably prevented that a commercial vehicle continues to travel unbraked and thus will be difficult to control.

This forced braking with a lack of a supply of compressed air is, in addition, also used in the case of trailers, etc. parked for some time, so that an unintended rolling-away of these vehicles can be prevented.

The braking effect which is thereby exercised by the mechanical spring in the spring brake cylinder in such cases, should, however, be releasable again, for example, for displacing parked vehicles or for clearing a driving lane blocked because of a breakdown, so that the concerned vehicles can be moved and, for example, traffic obstacles can be removed.

However, since the existing compressed-air supply is frequently damaged as a result of a tearing-off of the line, etc., and cannot be used and no supplementary compressed-air supply is available, it is required in practice that such spring brake cylinders have a mechanical emergency release device. The latter is normally provided with an operating device in the form of a threaded spindle which is accessible from the outside and is rotatably operable. In this case, this threaded spindle interacts in a known construction, as described in German Patent Document DE 198 30 154 A1, with an output element, such as a nut, arranged stationarily in the axial direction on the housing of the spring brake cylinder, so that a rotation of the threaded spindle causes a linear displacement of the latter. Here, in the case of this concrete embodiment, for example, the end of the threaded spindle which is on the inside in the axial direction is constructed with a projecting length which can be caused to come to rest by means of a contact surface on the spring-loaded piston. Because of the linear displacement of the threaded spindle in the axial direction initiated by the rotating movement, an also linear displacement of the spring-loaded piston against the pretensioning force of the spring device therefore takes place, so that, as a result, the brake device interacting with the spring-loaded piston can be released.

This construction has been successful in practice with respect to its functionality. However, it has the disadvantage that, for the mechanical emergency release, the threaded spindle has to be rotated relatively far out of the housing, which results in a considerable space requirement on this side of the spring brake cylinder. However, this space is intended for other components of the commercial vehicle or is limited by other moved components.

In order to solve this problem, an internal development line of the applicant provides another construction of the mechanical emergency release device. In the case of this design suggestion, the threaded spindle is stationarily fixed in the axial direction on the housing of the spring brake cylinder. However, simultaneously, the threaded spindle is rotatably disposed and, on the end accessible from the outside, is provided with an application surface for a turning tool, such as a hexagon head or the like, by means of which the threaded spindle can be caused to rotate. This threaded spindle engages in a central cavity of the spring-loaded piston, the threaded spindle engaging here with a hexagon nut which is non-rotatably disposed in the interior of the spring-loaded piston but is displaceably disposed in the axial direction. For releasing the spring brake, the threaded spindle is rotatingly operated here such that the nut moving along thereon is guided against a contact surface on the spring-loaded piston and, when the threaded spindle is rotated further, causes a taking-along of the spring-loaded piston against the pretensioning of the spring device in the spring chamber.

This construction has the significant advantage that here no exterior-side clearance is required for a rotating-out threaded spindle. However, this simultaneously has the disadvantage that it cannot be recognized from the outside whether the spring brake has been released, while this is still easily detectable in the construction according to the above-explained German Patent Document DE 198 30 154 A1 as a result of the rotated-out spindle. However, since very high spring forces act in such a spring brake cylinder, it is required for avoiding an endangering of persons working in this area that these persons will be able to detect the condition of the spring brake cylinder. In addition, particularly in the case of a heavy commercial vehicle, it should be easily recognizable, for example, during a towing operation whether and which brakes have already been released and which have not.

It is therefore an object of the present invention to further develop a spring brake cylinder in such a manner that it can be recognized from the outside whether or not the braking device cooperating with the spring brake cylinder has been released.

This object is achieved by means of a spring brake cylinder having the characteristics of claim 1.

Thus, it is provided for the first time in the case of such a spring brake cylinder to arrange an indicator device which indicates the position of the spring-loaded piston relative to the operating device. Here, it was recognized according to the invention that, as a result of a modification of the emergency release device, an indication of the operating condition of the spring brake cylinder can be achieved which is visible from the outside and is reliable at the same time. In this case, the constructive expenditures for providing such an indicator device can advantageously be minimized but the functionality of the mechanical emergency release device can remain completely unimpaired. The emergency release device can therefore have a compact construction, and a possible additional space for the indicator device is limited to very small measurements.

The providing of the indicator device according to the invention therefore permits a reliable checking of the operating condition of a spring brake cylinder, without requiring a construction with a threaded spindle, which rotates out, on the emergency release device, with the above-described disadvantages.

Advantageous further developments of the inventions are indicated by the characteristics of the subclaims.

Thus, the emergency release device can be constructed such that the indicator device indicates the position of the spring-loaded piston with respect to the operating device by its relative position with respect to the operating device. According to the load case, whether braked by the spring device in the spring chamber or not braked, it can be determined by only a visual comparison of the relative position of these two components of the emergency release device whether or not the braking device coupled with the spring brake cylinder has been operated. In darkness or under poor visual conditions, for example, such a comparison can also take place by touch. A checking of this situation can therefore be carried out very rapidly and with a high reliability.

Because of the fact that the operating device has a threaded spindle, which is rotatably fixed at the housing, in which case the threaded spindle engages with a nut used as an output element or a transmission device, which nut is axially displaceably and non-rotatably held in the emergency release device, and because of the fact that, for the mechanical emergency release of the spring brake cylinder, the nut can be placed by means of a contact surface against the spring-loaded piston, a particularly compact construction of the spring brake cylinder according to the invention is obtained, the indicator device being particularly easy to integrate therein.

Here, it is a further advantage if the indicator device has an indicator rod which reaches through the threaded spindle and is displaceable with respect to the latter. This indicator rod can therefore be used as a simple mechanical element with a high reliability as an indicator element for the respective position of the pressure-loaded piston with respect to the operating device. Because, in this case, the indicator rod reaches through the threaded spindle, it can be arranged in a constructively simple manner, and essentially no additional space is required for this purpose. As a rule, a retrofitting to known emergency release devices is also conceivable.

If, in addition, the indicator rod is pretensioned with respect to the threaded spindle by means of a spring, particularly in the inoperative condition, it is in a clearly defined end position, which leaves no doubt concerning the condition of the spring brake cylinder. This increases the functional reliability of the indicator device.

It is another advantage for a stop to be arranged in the area of one end of the indicator rod, which stop can be engaged with the nut. In this type of construction, the nut can advantageously be utilized not only for restoring the spring-loaded piston against the pretensioning of the spring device but also for operating the indicator device when the spring brake is operated; that is, no compressed air is present in the pressure chamber. The emergency release device according to the invention can therefore be made available in a more compact shape and with a smaller number of constructive elements.

In another embodiment, an end of the indicator rod, which is visible from the outside, can be visually highlighted with respect to the operating device, particularly a color design being provided for this purpose. As a result, the operating condition of the spring brake cylinder can be detected still more clearly and reliably.

In the following, the invention will be explained in detail by means of the single FIGURE of the drawing in an embodiment. This drawing is a sectional view of a spring brake cylinder according to the invention.

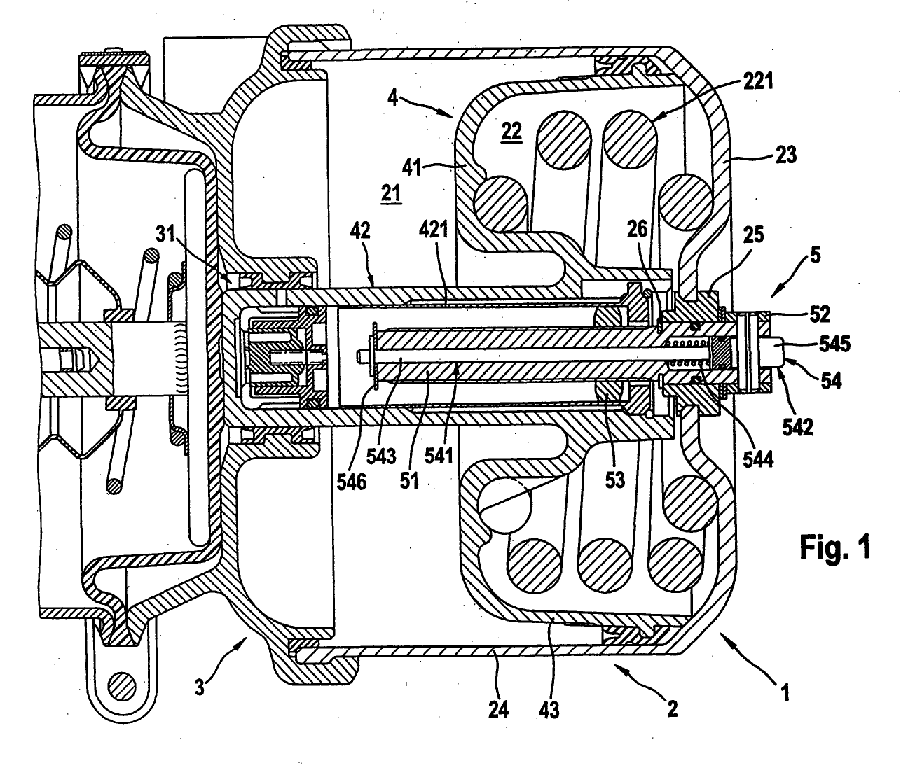

According to this FIG. 1, a spring brake cylinder 1 has a housing 2 to which a flange 3 is coupled in such a manner that the housing 2 and the flange 3 form an essentially closed unit. A service brake cylinder, which is only outlined here, can, for example, be coupled to the flange 3. A spring-loaded piston 4 is arranged in the interior of the housing 2 and divides this interior into a pressure chamber 21 and a spring chamber 22. In the spring chamber 22, a spring device 221 is arranged such that it develops its spring effect in the axial direction of the spring brake cylinder 1 and pretensions the spring-loaded piston 4 in the direction of the flange 3. In the process, this spring device 221 is, on the one side, supported on a floor 23 of the housing 2 and, on the other side, on a piston plate 41 of the spring-loaded piston 4.

The spring-loaded piston 4 also has a piston unit 42 which is integrally constructed with the piston plate 41 and, in a linearly displaceable manner, reaches by means of its free end through a central passage opening 31 of the flange 3. The spring-loaded piston 4 thereby acts upon the service brake cylinder outlined in FIG. 1. Furthermore, the spring-loaded piston 4 also has a guiding section 43 which extends in a sealed manner on the circumference side in a cylinder section 24 of the housing 2.

Furthermore, the spring brake cylinder 1 has an emergency release device 5 by means of which a mechanical emergency release of the spring brake can be achieved by manual exterior actions. In this embodiment, the emergency release device 5 is arranged centrically in the spring brake cylinder 1 and reaches through a central opening of the housing 2 into a cavity of the piston unit 42. It has a threaded spindle 51 on whose outer end a hexagon head 52 or the like, is non-rotatably fastened by means of a pin. The threaded spindle 51 reaches through a bush or a bearing part 25 of the housing 2 in such a manner that it is guided therein in a sealed-off fashion in order to be able to carry out a rotating movement. Simultaneously, the threaded spindle 51 is prevented by means of a locking washer 26 from carrying out an axial movement with respect to the housing 2.

In this case, the threaded spindle 51 and the hexagon head 52 act as an operating device which interacts with a transmission device in the form of a nut 53. This nut 53 engages with the course of the thread of the threaded spindle 51 such that a rotating movement of the threaded spindle 51 is translated into a linear movement of the nut 53 in the axial direction. For this purpose, the nut 53 constructed as a hexagon nut is form-lockingly received in a guiding part 421 in the cavity of the piston unit 42 so that it cannot rotate.

In addition, the emergency release device 5 has an indicator device 54. The latter contains an indicator rod 541 which has an indicating section 542 and a control section 543 of a smaller diameter which is stepped therefrom. The indicator rod 541 reaches in the center through the threaded spindle 51 and extends therein in a sealed-off manner such that a movement can take place in the axial direction. The indicator rod 541 is pretensioned means of a spring 544 with respect to a step section in the spindle 51 in such a manner that the indicating section 542 is pressed toward the outside. In the area of the indicating section 542, the indicator rod 541 also has a slot 545 through which the fastening pin for the hexagon head 52 on the threaded spindle 51 reaches such that a linear displacement of the indicator rod 541 can be achieved to a defined extent.

At the end of the control section 543 away from the indicating section 542, in addition, a disk 546 is arranged which is arranged transversely to the axial direction, is used as a stop, reaches around the control section 543 and, on the circumference side, projects therefrom in such a manner that the outer edge of the disk 546 can come to rest against the nut 53. In this case, the disk 546 is fixed by means of a lock washer on the control section 543.

FIG. 1 shows the case in which the emergency release device 5 of the spring brake cylinder 1 was operated and the braking effect of the spring brake was thereby discontinued. For this purpose, a lateral surface of the nut 53 is situated on a contact section of the piston plate 41 and has pulled the latter in the course of the rotating movement of the threaded spindle 51 against the pretensioning of the spring device 221 in the spring chamber 22 in the direction of the floor 23 of the housing 2. According to the representation in FIG. 1, the indicating section 542 of the indicator rod 541 is thereby acted upon by the spring 544 in such a manner that an outer end thereof projects toward the outside beyond the hexagon head 52 and thereby indicates that the spring brake cylinder 1 has been emergency-released.

If this spring brake cylinder 1 now is to be used again in the conventional manner, the threaded spindle 51 is rotated by means of the hexagon head 52 such that the nut 53 moves in the axial direction away from the floor 23 of the housing 2. As a result of the pretensioning by the spring device 221 in the spring chamber 22, the piston plate 41 follows this movement, the lateral surface of the nut 53 thereby remaining in contact with respect to the opposite surface on the piston plate 41. With the piston plate 41, the piston unit 42 also moves away from the floor 23 of the housing 2, so that a braking force is exercised on the braking device on the other side of the flange 3, which braking device is not shown here. However, as soon as the maximal braking force is applied, the piston plate 41 will not continue to follow the nut 53.

For a normal operation of the spring brake cylinder 1, by way of an air inlet not shown here, compressed air would be introduced into the pressure space 21 in a controlled manner such that this compressed air overcomes the spring force of the spring in the spring chamber 22 and, in this manner, optionally, as a function of the amount of the pressure, releases or operates the brake.

As a result of a continued screwing of the nut 53 into the piston unit 42, it finally comes to engage with the disk 546 of the indicator device 54 and thereby permits a linear displacement of the indicator rod 541 against the spring force of the spring 544. The indicating section 542 is thereby moved relative to the hexagon head 52 or the outer end of the threaded spindle 51 such that it is pulled in until it is situated essentially flush therewith. This indicates to the user that the spring brake cylinder 1 has not been manually emergency-released. The spring brake cylinder 1 will then be in the normal operating position in which the brake operation is either triggered by the action of compressed air or, if no compressed air is present, a braking effect is triggered by the accumulator-type spring. In other words, the condition shown in FIG. 1 represents the special case in which the spring brake cylinder 1 was manually emergency-released.

In addition to the explained embodiment, the invention allows further developments.

Thus, the emergency-released condition of the spring brake cylinder 1, in addition to being detectable by the protruding end of the indicating section 542, can also be detected from the outside by means of a special color. The indicating section 542 could, for example, be dyed red at its extreme end for this purpose.

Furthermore, it is also conceivable to construct the indicator device 54 such that the displacement of the disk 546 with respect to the threaded spindle 51 by means of the nut 53 can be indicated to the exterior side also in a manner different than the mechanical taking-along of the entire indicator rod 541. For this purpose, an electrical signal transmission is, for example, also conceivable. A projecting section of the indicator device on the exterior side of the spring brake cylinder 1 will then not be necessary.

Instead of having the indicator rod, the indicating device may, for example, be equipped with a spindle, a tube, etc. and be constructively modified correspondingly.

Instead of the disk 546, a cross-pin or the like, which reaches through the control section 543, may also be used as a stop for the nut 53.

As in the embodiment explained above, the transmission device may be a conventional hexagon nut; however, as an alternative, a construction can be implemented in which a threaded bush, for example, with a longitudinal groove or a star toothing, etc. is used as a protection against torsion in this case. The guiding part 421 will then be replaced by a correspondingly adapted other device.

Furthermore, instead of being provided with the guiding section 43, the spring-loaded piston 4 may be equipped with a membrane which serves as a separating element between the pressure chamber 21 and the spring chamber 22. The guide in the cylinder section 24 of the housing 2 can thereby be eliminated.

The special construction of the emergency release device 5 may deviate from the illustrated embodiment, so that a taking-along of the spring-loaded piston 4 can also take place in a different manner by a manual external engagement. Because of its compact and simple construction, the indicator device 54 according to the invention can be used on different systems of emergency release devices.

The invention therefore provides a spring brake cylinder 1 having a housing 2 in which a spring-loaded piston 4 is arranged which divides an interior of the housing 2 into a spring chamber 22 and a pressure chamber, having a spring device 221 which is arranged in the spring chamber 22 and pretensions the spring-loaded piston 4 in the direction of the pressure chamber 21, and having a mechanical emergency release device 5 which is used for the mechanical emergency release of the spring brake cylinder 1. For this purpose, a linear displacement of the spring-loaded piston 4 against the pretensioning by the spring device 221 can be caused by means of the mechanical emergency release device 5, a threaded spindle 51 acting as the operating device being stationarily fixed in the axial direction on the housing 2, the emergency release device 5 also having an indicator device 54 which indicates the position of the spring-loaded piston 4 with respect to the operating device. As a result, it becomes possible, particularly also in the case of an emergency release device whose threaded spindle is not rotated to the outside, to provide a reliable indication of whether or not the spring brake cylinder was emergency-released.

1. Spring brake cylinder (1) having a housing (2), in which a spring-loaded piston (4) is arranged which divides an interior of the housing (2) into a spring chamber (22) and a pressure chamber (21), having a spring device (221), which is arranged in the spring chamber (22) and pretensions the spring-loaded piston (4) in the direction of the pressure space (21, and having a mechanical emergency release device (5) which has an operating device and a transmission device for the mechanical emergency release of the spring brake cylinder (1),
wherein, by means of the emergency release device (5), an axial displacement of the spring-loaded piston (4) can be caused against the pretensioning of the spring device, wherein the operating device is stationarily in the axial direction fixed on the housing (2), and wherein the emergency release device (5) also has an indicator device (54) which indicates the position of the spring-loaded piston (4) with respect to the operating device.

2. Spring brake cylinder according to claim 1, characterized in that the indicator device (54), as a result of its relative position with respect to the operating device, indicates the position of the spring-loaded piston (4) relative to the operating device.

3. Spring brake cylinder according to claim 1 or 2, characterized in that the operating device has a threaded spindle (51) which is rotatably fixed on the housing (2), the threaded spindle (51) engaging with a nut (53) serving as the transmission device, which nut (53) is axially displaceably and non-rotatably held in the emergency release device (5), and the nut (53) being placeable against a contact surface on the spring-loaded piston (4) for the mechanical emergency release of the spring brake cylinder (1).

4. Spring brake cylinder according to claim 3, characterized in that the indicator device (54) has an indicator rod (541) which reaches through the threaded spindle (51) and is displaceable with respect to the latter in the axial direction.

5. Spring brake cylinder according to claim 4, characterized in that the indicator rod (541) is pretensioned by means of a spring (544) with respect to the threaded spindle (51).

6. Spring brake cylinder according to claim 4 or 5, characterized in that, in the area of one end of the indicator rod (541), a stop (546) is arranged which can be engaged with the nut (53).

7. Spring brake cylinder according to one of claims 4 to 6, characterized in that an end of the indicator rod (541) visible from the outside is visually highlighted, particularly by color, with respect to the operating device.
